(19) United States
(12) Patent Application Publication
(10) Pub. No.: US 2008/0252574 A1
(43) Pub. Date: Oct. 16, 2008

(54) LED display apparatus

(75) Inventors: Hiroyuki Sakai, Tokyo (JP); Takehiro Koyama, Tokyo (JP); Hideki Muramatsu, Tokyo (JP); Toshiaki Kobayashi, Tokyo (JP)

Correspondence Address: BIRCH STEWART KOLASCH & BIRCH, PO BOX 747, FALLS CHURCH, VA, 22040-0747, US

(73) Assignee: Nagano Keiki Co., Ltd.

(21) Appl. No.: 11/979,042

(22) Filed: Oct. 30, 2007

(30) Foreign Application Priority Data
Apr. 16, 2007 (JP) 2007-106977

(51) Int. Cl. G09G 3/32

(52) U.S. Cl. 345/82

(57) ABSTRACT

An LED display apparatus 1 in which at least multiple LEDs are serially-connected to a power circuit part having a constant current power source, each one of the LEDs has a switching element parallel-connected thereto, and a control circuit part is used to selectively turn on/off the switching elements to control the LEDs for a specific display, characterized by the fact that the apparatus comprises a display matrix circuit part 9 constituted by parallel-connecting to the power circuit part 8 multiple LED circuits 7a, 7b, 7c . . . consisting of multiple LEDs 2 . . . and a single first switching element 3a, 3b, 3c . . . serially-connected and second switching element 4 . . . each parallel-connected to one of the LEDs 2 . . . , and a control circuit part 10 turning on the first switching elements 3a . . . for a given time period (Ts) in sequence and turning on/off a row La, Lb, Lc . . . of multiple second switching elements 4 . . . extending across the LED circuits 7a . . . of the display matrix circuit part 9 in correspondence with the first switch 3a . . . being turned on.

### BACKGROUND OF THE INVENTION

1. Field of the Invention

The present invention relates to an LED display apparatus in which switching elements are parallel-connected to multiple serially-connected LEDs, respectively, and turned on/off to display figures and the like.

2. Description of the Related Art

LED display apparatuses using multiple LEDs to display figures and the like are known. The normally-on LED display apparatus must satisfy general requirements such as small size, low price, and high quality display and other performances, particularly low power consumption and operation with a low voltage power source.

Such LED display apparatuses are known from the Japanese Patent Publication Nos. 9 (1997)-81211 (Patent Document 1), 5 (1993)-129665 (Patent Document 2), 5 (1993)-131681 (Patent Document 3), 8 (1996)-194448 (Patent Document 4), and 2001-109433 (Patent Document 5). Patent Document 1 discloses a display circuit having a constant current power source, multiple serially-connected light emitting elements serially-connected to the constant current power source, and bypass circuits provided one each to the light emitting elements and parallel-connected to the corresponding one of them wherein the bypass circuit shorts between the ends of the corresponding light emitting element at sufficiently smaller resistance than that of the corresponding light emitting element in response to supplied control signals. Patent Document 2 discloses an LED drive circuit comprising a set of light emitting elements serially-connected in the forward direction, a constant current power source supplying the set of light emitting elements with a constant current, a set of switching elements each parallel-connected to one of the set of light emitting elements to turn on/off the corresponding light emitting element based on external control signals. Patent Document 3 discloses an LED array apparatus comprising an LED array consisting of a number of LEDs juxtaposed and a circuit controlling the conduction of the individual LEDs wherein the LED array apparatus is provided with an LED array consisting of serially-connected LEDs, switching elements each parallel-connected to one of the LEDs, and a constant current unit powering the LED array. Patent Document 4 discloses a display apparatus comprising a light source constituted by a serial element consisting of multiple serially-connected LEDs wherein a constant current element is serially-connected to the serial element. Patent Document 5 discloses a dot matrix display apparatus in which multiple scanning electrodes and multiple signal electrodes intersect in a matrix form and a display element is driven by the voltage between the scanning electrode and the signal electrode at each intersection of the matrix wherein a rectifying element is electrically connected in a specific electrode direction between a scanning electrode and a reference voltage terminal supplying a given reference potential and the charge on the scanning electrode is discharged to the reference voltage terminal via the rectifying element.

However, the above described prior art LED display apparatuses have the following problems.

First, a necessary number of LEDs are serially-connected in Patent Documents 1, 2 and 3. Therefore, in Patent Documents 1, 2 and 3, a higher drive voltage is required in correspondence with the number of LEDs to be used, leading to a larger power source and increased cost. If a higher drive voltage is not available, the number of LEDs to be used is limited or their luminance may be lowered. When the LEDs are parallel-connected, the luminance may not be uniform and the power consumption is increased.

A necessary number of LEDs are used in a combination of serial-connection and parallel-connection, in other words they are connected in a matrix array in Patent Documents 4 and 5. When a matrix connection is used, the drawbacks with the serial-connection and parallel-connection can be eliminated to a certain extent. However, the parallel circuits (row) or serial circuits (column) are controlled as a group. Therefore, the individual LEDs are not controlled, disadvantageously limiting display applications.

### SUMMARY OF THE INVENTION

A purpose of the present invention is to provide an LED display apparatus that allows for a down-sized power circuit part and reduced cost, eliminates inconvenient limitation on the number of LEDs to be used and lowered luminance, and realizes uniform luminance and low power consumption, thereby resolving the prior art contradictive problems in particular.

Another purpose of the present invention is to provide an LED display apparatus that eliminates inconvenient limitation on display applications, increases universality, and realizing more versatile displays.

In order to achieve the above purposes, the present invention provides an LED display apparatus in which at least multiple LEDs are serially-connected to a power circuit part having a constant current power source, each one of the LEDs has a switching element parallel-connected thereto, and a control circuit part is used to selectively turn on/off the switching elements to control the LEDs for a specific display, characterized by the fact that the apparatus comprises a display matrix circuit part constituted by parallel-connecting to the power circuit part multiple LED circuits each consisting of multiple LEDs and a single first switching element serially-connected and second switching elements each parallel-connected to one of the LEDs, and a control circuit part turning on the first switching elements for a given time period in sequence and turning on/off a row of multiple second switching elements extending across the LED circuits of the display matrix circuit part in correspondence with the first switch element being turned on.

### BRIEF DESCRIPTION OF THE DRAWINGS

FIG. 1 is an electric circuit diagram showing the basic structure of the core part of an LED display apparatus according to the best embodiment of the present invention.

FIG. 2 is an electric circuit diagram more specifically showing the basic structure of the LED display apparatus.

FIG. 3 is a perspective view of the exterior of a pressure gauge having the LED display apparatus.

FIG. 4 is a plane view of the exterior of the LED display apparatus.

FIG. 5 is a block diagram of the electric system installed in the pressure gauge.

FIG. 6 is a diagram of connection lines showing an application of the pressure gauge.

FIG. 7 is an operation timing chart of the LED display apparatus.

FIG. 8 is another operation timing chart of the LED display apparatus.

FIG. 9 is a further other operation timing chart of the LED display apparatus.

### DETAILED DESCRIPTION OF THE PREFERRED EMBODIMENT

A preferred embodiment of the present invention is described in detail hereafter with reference to the drawings. The attached drawings are intended to facilitate the understanding of the present invention, not to restrict the present invention. Known matters are not described in detail to prevent the present invention from becoming unclear.

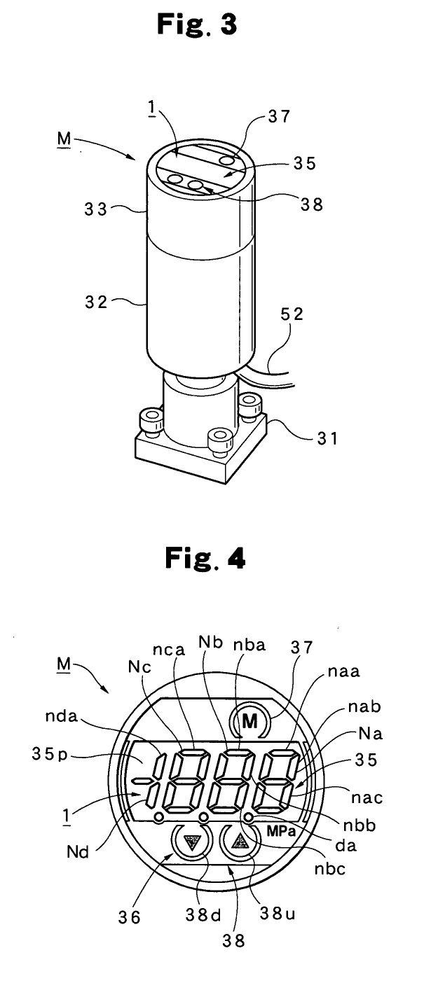

A pressure gauge M for which an LED display apparatus 1 according to this embodiment is preferably used is outlined with reference to FIGS. 3 to 6.

FIGS. 3 and 4 show the exterior of a pressure gauge M. The pressure gauge M has a mounting part 31 for mounting to a detection object A shown in FIG. 6, a detection body 32 integrated with the mounting part 31, and a processing body 33 attached to the detection body 32.

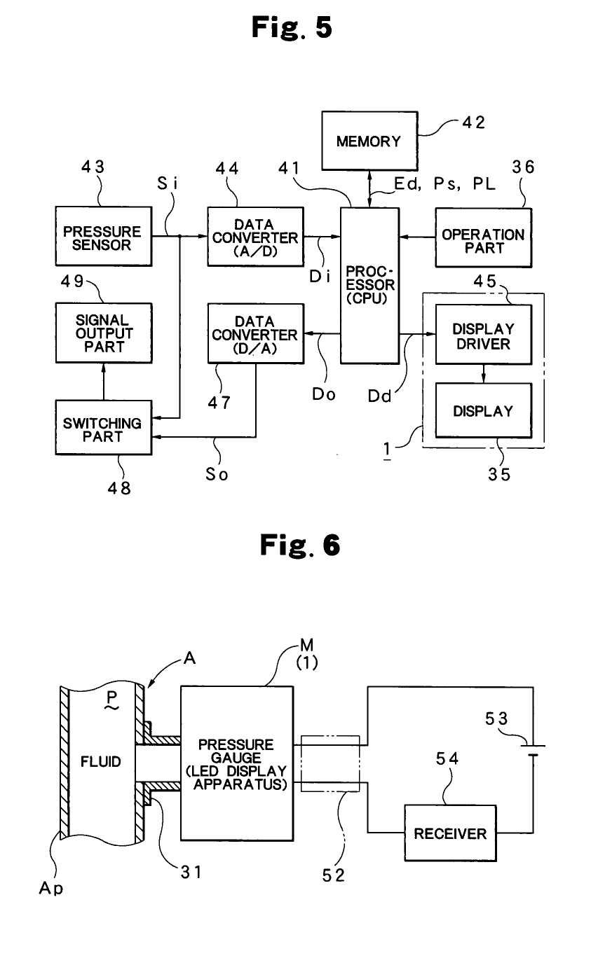

The detection body 32 has a cylindrical exterior and contains a pressure sensor 43 (FIG. 5) consisting of a strain gauge formed on a metal diaphragm by PCVD process. On the other hand, the processing body 33 having a cylindrical exterior is attached to the top surface of the detection body 32. A display 35 and an operation part 36 as shown in FIG. 4 are provided on the top surface of the processing body 33. The display 35 has an LED display panel 35p. The display 35 is constituted by the LED display apparatus 1 according to this embodiment. The operation part 36 has a mode key 37 for switching the modes and an up/down key 38 consisting of an up key 38u, and a down key 38d. The processing body 33 can be rotated about the axis of the detection body 32 to change the orientation (angle) of the display 35.

FIG. 5 is a block diagram of the electric system installed in the pressure gauge M. A processor 41 executing various calculations comprises a microcomputer including a CPU. The processor 41 has a memory 42 connected thereto for storing various data. A pressure sensor 43 detects a pressure (applied pressure) P of the detection object A and outputs a detected signal Si corresponding to the applied pressure P. The detected signal Si is supplied to the processor 41 via an input data converter 44. The input data converter 44 amplifies the detected signal Si, which is an analog signal, to a specific level using an amplifying circuit and converts it to an input signal (digital signal) Di for example at 10 [ms] intervals using an analog-digital (A/D) conversion function.

On the other hand, the LED display apparatus 1 according this embodiment is connected to the processor 41. The LED display apparatus 1 consists of a display driver 45 connected to the processor 41 and a display 35 connected to the display driver 45. The input signal Di is converted to a pressure value corresponding to the applied pressure P in the processor 41. Then, a processed signal Dd corresponding to the pressure value is supplied to the display driver 45 and the pressure value is displayed on the display 35. The operation part 36 including the mode key 37 and up/down key 38 is also connected to the processor 41.

Furthermore, an output data converter 47 is connected to the processor 41. The processor 41 supplies an output signal (digital signal) Do corresponding to the pressure value to the output data converter 47 at 10 [ms] intervals. The output data converter 47 converts the output signal Do to an analog output signal So using a digital-analog (D/A) conversion function. The output signal So is supplied to a signal output part 49 via an output switching part 48. The output switching part 48 also receives the detected signal Si from the pressure sensor 43. In this way, the output signal So or the detected signal Si is selectively supplied to the signal output part 49 as the output switching part 48 is switched. The signal output part 49 converts these signals to an output signal of, for example, DC 4 to 20 [mA], DC 1 to 5 [V] and externally outputs it via a connection cable 52 described later. The signal output part 49 advantageously allows various signals to be externally output. The output system can be realized by a switching means such as a transistor or relay that is turned on/off by the processor 41 to externally output digital signals using an open collector or contact output.

FIG. 6 shows an application of the pressure gauge M. The pressure gauge M is mounted, for example, onto a pipe Ap through which fluid or a detection object A such as gas and oil flows via the mounting part 31. The pressure gauge M is connected to a series circuit of a DC power source (direct current power source) 53 and a receiver 54 in a two-wire transfer system via the connection cable 52.

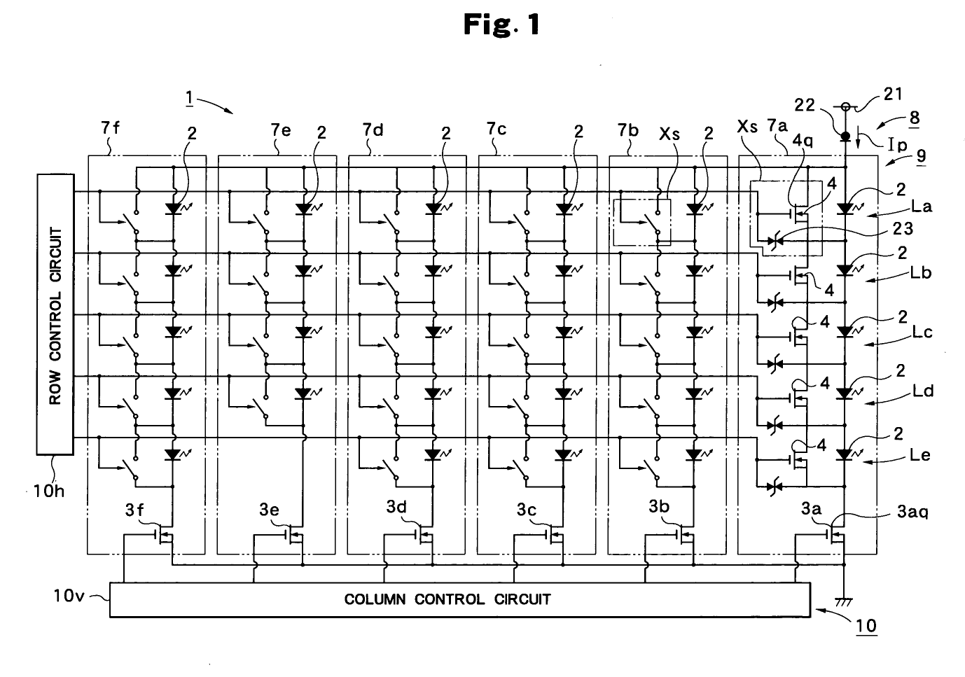

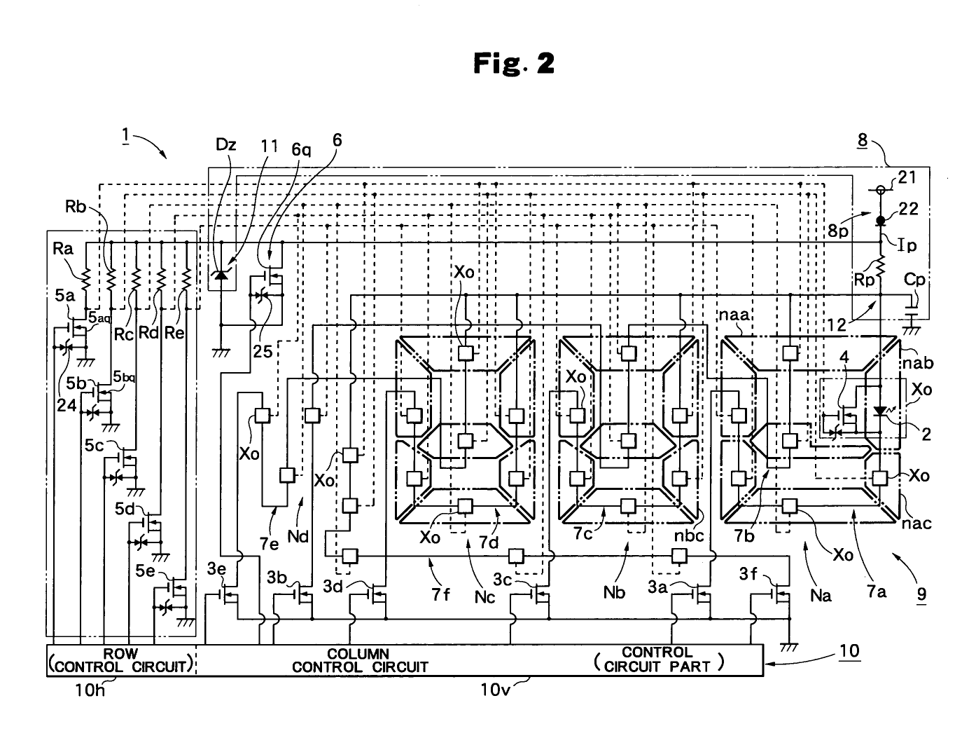

The structure of the LED display apparatus 1 according to this embodiment is described hereafter with reference to FIGS. 1 and 2.

The LED display apparatus 1 has the display 35 and the display driver 45 connected to the display 35. As shown in FIG. 4, the display 35 uses an LED display panel 35p to display at least 3.5 seven-segment figures Na, Nb, Nc, and Nd. The segments naa, nab, nac, . . . , nba, nbb, nbc . . . , nca . . . , nda, . . . of the figures Na, Nb, Nc, . . . and dots da . . . are formed by LEDs (light emitting diodes) 2 . . . The components of the LED display apparatus 1 except for LED 2 . . . constitute the display driver 45.

On the other hand, the display driver 45 has main components such as a power circuit part 8, a display matrix circuit part 9, and a control circuit part 10 as shown in FIGS. 1 and 2. FIG. 1 shows their basic structure and FIG. 2 shows more specific circuits than FIG. 1.

The power circuit part 8 comprises a constant current power source 8p as shown in FIG. 2. The constant current power source 8p consists of a constant current diode (constant current element) 22 connected to a direct current hot line 21. The power circuit part 8 further comprises an integration circuit 12 connected to the constant current power source 8p. The integration circuit 12 consists of a resistor Rp connected between the cathode of the constant current diode 22 and the display matrix circuit part 9 described later and a capacitor Cp connected between the current output end of the resistor Rp and the ground. The power circuit part 8 comprises a constant voltage circuit 11 using a zener diode Dz connected between the cathode of the constant current diode 22 and the ground.

The display matrix part 9 comprises six parallel-connected LED circuits 7a, 7b, 7c, and 7f as shown in FIG. 1. Then, the LEDs 2 . . . form a matrix array. The display matrix circuit part 9 is connected to the power circuit part 8 at the hot line connection point and to the ground at the ground connection point. The LED circuit 7a is constituted by serially-connecting five LEDs 2 . . . and a single first switching element 3a and parallel-connecting a second switching element 4 . . . to each one of the LEDs 2 . . . . In this case, the first switching element 3a is an n-type FET 3aq and the second switching elements 4 . . . are n-type FETs 4q . . . . In the figure, the number 23 presents a bidirectional zener diode connected between the gate and the sources of each FET 4q . . . . The LED circuits 7b, 7c, 7d, and 7f other than the LED circuit 7e have the same structure as the LED circuit 7a. The LED circuit 7e has the same structure as the LED circuit 7a except that four LEDs 2 . . . are provided. In FIG. 1, the numbers 3b, 3c, 3d, . . . , and 3f present the first switching elements and the second switching elements 4 . . . are omitted in the LED circuits 7b, 7c, 7d, . . . , and 7f. The circuits Xs enclosed by dash-dot-dot lines in the LED circuits 7b . . . other than the LED circuit 7a are the same as Xs enclosed by dash-dot-dot lines in the LED circuit 7a.

The LEDs 2 . . . in one or more LED circuits 7a . . . extend over multiple digits (figures Na, Nb, . . . ) as shown in FIG. 2. For example, the LED circuit 7b has two LEDs 2 . . . provided for the least significant digit (the figure Na), two LEDs 2 . . . provided for the next higher digit (the figure Nb), and one LED 2 provided for the most significant digit (the figure Nc). In FIG. 2, the circuit Xo enclosed by dash-dot-dot lines in the LED circuit 7a and the open blocks Xo are the same. This arrangement of the LEDs 2 . . . advantageously allows the LED circuits 7a . . . to easily have an equal control voltage and accordingly an equal luminance.

The control circuit part 10 comprises a column control circuit 10v and a row control circuit 10h controlling the columns and the rows of the display matrix circuit part 9, respectively. The column control circuit 10v has a function to turn on/off the first switching elements 3a of the display matrix circuit part 9, in other words a function to turn on the first switching elements 3a for a given time period (Ts) in sequence. Therefore, the gates of the FETs 3aq . . . are connected to the column control circuit 10v.

On the other hand, the row control circuit 10h has a function to simultaneously turn on/off a row La, Lb, Lc, . . . , or Le of six second switching elements 4 extending across the LED circuits 7a, 7b, 7c, . . . , and 7f, in other words a function to turn on/off a row La, Lb, Lc, . . . , or Le of six second switching elements 4 in correspondence with the first switching elements 3a being turned on. To do so, the row control circuit 10h has five third switching elements 5a, 5b, 5c, . . . , and 5e for simultaneously turning on/off a row La, Lb, Lc, . . . , or Le of six second switches 4 extending across the LED circuits 7a, 7b, 7c, . . . , and 7f as shown in FIG. 2. The third switching elements 5a, 5b . . . are connected to the constant current power source 8p (the cathode of the constant current diode 22) via current limiting resistors Ra, Rb, Rc, . . . , and Re, respectively. In this case, the third switching elements 5a, 5b, . . . , and 5e are n-type FETs 5aq, 5bq . . . . The number 24 presents a bidirectional zener diode connected between the gate and the sources of each FET 5aq . . . . Then, the gates of the FET 4q . . . are connected to the drains of the corresponding FET 5aq, 5bq . . . (see the circuit Xo in FIG. 2) and the gates of the FETs 5aq, 5bq . . . are connected to the row control circuit 10h.

The third switching elements 5a . . . and current limiting resistors Ra . . . are provided for the following reasons. The gate voltage for turning on the FETs 4q . . . (second switching elements 4 . . . ) has to be higher than the source voltage at least by 1 [V]. The source voltage of the FETs 4q . . . varies depending on the number of subsequent LEDs 2 . . . connected to be turned on and becomes higher as the number is increased. Then, the voltage for turning on the FET 4q . . . must be very high in some cases. In such a case, the output port that cannot supply a higher voltage than the power voltage of the microcomputer (processor 41) may not be useful for controlling. Therefore, the gate voltage of the FETs 4q . . . is supplied from the cathode of the constant current diode 22 via the FETs 5aq, 5bq . . . (third switching elements 5a, 5b . . . ) and the row control circuit 10h is used to turn on/off the FETs 5aq, 5bq . . . . In this way, when the third switching elements 5a, 5b . . . consist of the FETs 5aq, 5bq . . . , respectively, the gate voltage of the FETs 5aq, 5bq . . . can be approximately 1 [V] provided that the source voltage is at the ground level. In this way, the FETs 5aq . . . (third switch elements 5a . . . ) can be controlled with low voltage and constant voltage using the output port of the microcomputer (processor 41) and the FETs 4q . . . (second switching elements 4 . . . ) can also be controlled. The current limiting resistors Ra, Rb, . . . , and Re serve to prevent the supply current Ip from the constant current diode 22 from branching into the third switching elements 5a . . . . With the above structure, the second switching elements 4 . . . can be turned on/off in a stable manner regardless of the number of the LEDs 2 . . . in each LED circuit 7a . . . .

Furthermore, a fourth switching element 6 is connected between the constant current power source 8p and the ground. The column control circuit 10v (control circuit part 10) has a function to turn on the fourth switching element 6 for a given time period Tm . . . including the turn-off period To . . . of the first switching elements 3a, 3b . . . . The fourth switching element 6 is an n-type FET 6q, the gate of which is connected to the column control circuit 10v. The number 25 . . . presents a bidirectional zener diode connected between the gate and the source of the FET 6q. The fourth switching element 6 serves as a dummy circuit for the LED circuits 7a . . . to achieve a magnitude-stabilized (continuous) supply current Ip, thereby reducing the switching noise that occurs when the first switching elements 3a . . . are turned on/off.

Operation of the LED display apparatus 1 according to this embodiment is described hereafter with reference to FIGS. 1, 2, and 7 to 9.

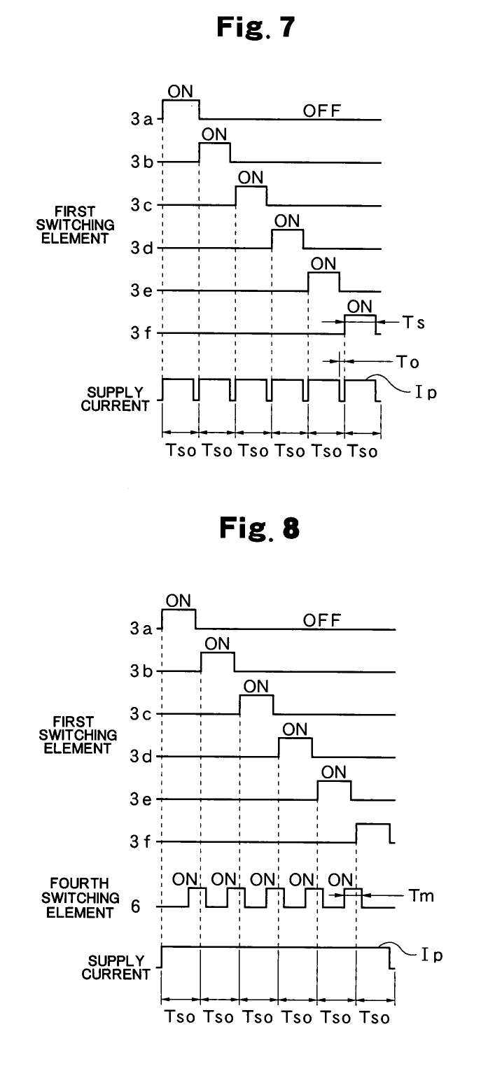

First, as shown in FIG. 7, the column control circuit 10v turns on the first switching elements 3a . . . for a given time period (Ts) in sequence. In other words, it performs dynamic drive control. The scan cycle Tso (scan speed) is set for around 1 [ms] at which no shimmering is observed. Meanwhile, a turn-off period To occurs after one first switching element 3a . . . is tuned off and before the next first switching element 3b . . . is turned on. Consequently, an intermittent supply current Ip flows through the constant current diode 22 in accordance with the turn-on/turn-off of the first switching elements 3a . . . , causing the switching noise. However, with the provision of the fourth switching element 6, the supply current Ip flows while the fourth switching element 6 is turned on for a given time period Tm . . . including the turn-off period To . . . of the first switching elements 3a, 3b . . . as shown in FIG. 8, achieving a magnitude-stabilized (continuous) supply current Ip, thereby reducing the switching noise that occurs when the first switching elements 3a . . . are turned on/off.

On the other hand, in this state, the row control circuit 10h simultaneously turns on/off a row La, Lb, Lc . . . of multiple second switch elements 4 . . . extending across the LED circuits 7a, 7b, 7c, . . . , and 7f in correspondence with the figure Na, Nb . . . to be displayed; in other words, it turns on/off the third switching elements 5a, 5b . . . in correspondence with the turn-on period of the first switching elements 3a, 3b . . . . Here, the second switching elements 4 . . . and third switching elements 5a . . . are FETs. Therefore, when the third switching elements 5a . . . are turned on, the second switching elements 4 . . . are turned off, whereby the LEDs 2 . . . are turned on. When the third switching elements 5a . . . are turned off, the second switching elements 4 . . . are turned on, whereby the LEDs 2 . . . are turned off. In this way, the LEDs 2 . . . of which the first switching element 3a . . . is turned on and the third switching element 5a . . . is turned on is turned on. When the LEDs 2 . . . are turned on, the supply current Ip flows from the hot line 21 to the LED circuits 7a . . . via the constant current diode 22 and integration circuit 12.

The integration circuit 12 functions as follows. In the LED circuits 7a, 7b . . . , the gate voltage of the FETs 4q . . . (second switching elements 4 . . . ) is supplied from the cathode of the constant current diode 22. When the LED circuits 7a, 7b . . . are switched by the FETs 3aq . . . (first switching elements 3a . . . ), the supply current IP may flow to the LEDs 2 . . . before it is determined whether or not the FETs 4q . . . are tuned on/off. This results in unstable turn-on/turn-off control of the LEDs 2 . . . . Therefore, the integration circuit 12 forces the supply current Ip to delay so that it is determined whether or not the FETs 4q . . . are turned on/off before the supply current Ip flows to the LEDs 2 . . . . In this way, inconvenient unstable turn-on/turn-off control of the FETs 4q . . . is eliminated and the LEDs 2 . . . are turned on in a stable manner. The resistors Rp serve to prevent the gate voltage of the FETs 4q . . . from becoming lower than the source voltage. In other words, the resistors Rp serve to forcefully establish a potential difference between the gate and the source of the FETs 4q . . . to reliably turn on the FETs 4q . . . (second switching element 4 . . . ).

When the cathode of the constant current diode 22 has no load while the FETs 3aq . . . (first switching elements 3a . . . ) are turned on/off, the cathode voltage of the constant current diode 22 is increased to the voltage of the hot line 21 and an excessive voltage may be applied between the gate and the source of the FETs 4q . . . (second switching elements 4 . . . ). The zener diodes Dz (constant voltage circuit 11) in the power circuits 8 protect the FETs 4q . . . against this excessive voltage.

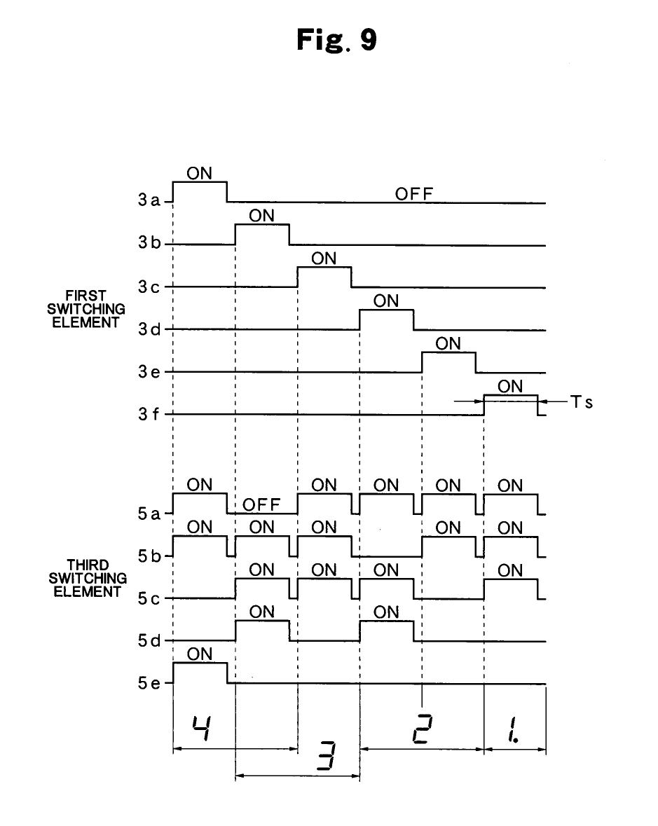

FIG. 9 shows an embodiment of the above control to display “1.234.” In this case, when the first switching element 3a is turned on, three third switching elements 5a, 5b, and 5e are turned on. When the first switching element 3b is turned on, three third switching elements 5b, 5c, and 5d are turned on. When the first switching element 3c is turned on, three third switching elements 5a, 5b, and 5c are turned on. When the first switching element 3d is turned on, three third switching elements 5a, 5c, and 5d are turned on. When the first switching element 3e is turned on, two third switching elements 5a and 5b are turned on. When the first switching element 3f is turned on, three third switching elements 5a, 5b, and 5c are turned on.

Consequently, when the first switching element 3a is turned on and when the first switching element 3b is turned on, a figure “4” is displayed as the least significant digit (the figure Na). When the first switching element 3b is turned on and when the first switching element 3c is turned on, a figure “3” is displayed as the next higher digit (the figure Nb). When the first switching element 3d is turned on and when the first switching element 3e is turned on, a figure “2” is displayed as the next higher digit (the figure Nc). When the first switching element 3f is turned on, a figure “1” is displayed as the next higher digit (the figure Nd) and a dot “.” is displayed by a dot da. Then, the LED display panel 35p displays “1.234.”

In the LED display apparatus 1 according to this embodiment, a low drive voltage can be used even if the number of LEDs 2 . . . to be used is increased, leading to down-sizing of the power circuit part 8 and reduced cost and eliminating inconvenient limitation on the number of LEDs 2 . . . to be used or reduced luminance. Furthermore, uniform luminance and reduced power consumption are achieved, resolving the prior art contradictory problems in particular. Even when the display matrix circuit part 9 is used, the LEDs 2 . . . are individually controlled, eliminating inconvenient limitation on display applications and allowing for higher universality and versatile displays. Furthermore, the LEDs 2 . . . constitute the segments naa, nab, nac, . . . , nba, nbb, nbc . . . of at least one or more figures Na, Nb . . . , which is suitable for the distal display system using such figures Na, Nb . . . .

The best embodiment is described in detail above. The present invention is not restricted to this embodiment and any modifications in detailed structure, shape, material, quantity, and numerical value can be made without departing from the scope of the present invention and so can any additions or omissions where necessary. For example, the LED display apparatus 1 is applied to a pressure gauge M. The pressure gauge M is not necessarily the described one. The LED display apparatus 1 can be used as an LED display apparatuses for similar displays in other various types of pressure gauges and various applications other than pressure gauges. In such cases, the display can include not only figures but also various displays such as characters and images.

1. An LED display apparatus in which at least multiple LEDs are serially-connected to a power circuit part having a constant current power source, each one of said LEDs has a switching element parallel-connected thereto, and a control circuit part is used to selectively turn on/off said switching elements to control said LEDs for a specific display, characterized by the fact that said apparatus comprises a display matrix circuit part constituted by parallel-connecting to said power circuit part multiple LED circuits each consisting of multiple LEDs and a single first switching element serially-connected and second switching elements each parallel-connected to one of said LEDs, and a control circuit part turning on said first switching elements for a given time period in sequence and turning on/off a row of multiple second switching elements extending across said LED circuits of said display matrix circuit part in correspondence with said first switch element being turned on.

2. The LED display apparatus according to claim 1 characterized by the fact that said LEDs constitute segments of at least one or more figures.

3. The LED display apparatus according to claim 2 characterized by the fact that one or more of said LED circuits have LEDs extending over multiple figures.

4. The LED display apparatus according to claim 1 characterized by the fact that said first switching elements are FETs.

5. The LED display apparatus according to claim 1 characterized by the fact that said second switching elements are FETs.

6. The LED display apparatus according to claim 1 characterized by the fact that said power circuit part has a constant voltage circuit using a zener diode.

7. The LED display apparatus according to claim 1 characterized by the fact that said power circuit part has an integration circuit constituted by a resistor connected between said constant current power source and said display matrix circuit part and a capacitor connected between the current-output end of said resistor and the ground.

8. The LED display apparatus according to claim 1 characterized by the fact that multiple third switching elements simultaneously turning on/ff a row of multiple second switching elements extending across said LED circuits of said display matrix circuit part are provided and said third switching elements are connected to said constant current power source via respective current limiting resistors.

9. The LED display apparatus according to claim 8 characterized by the fact that said third switching elements are FETs.

10. The LED display apparatus according to claim 1 characterized by the fact that a fourth switching element is connected between said constant current power source and the ground and said control circuit part has a function to turn on said fourth switching element for a given time period including the turn-off period of said first switching elements.

11. The LED display apparatus according to claim 10 characterized by the fact that said fourth switching element is an FET.

12. The LED display apparatus according to claim 1 characterized by being used in a pressure gauge.

13. The LED display apparatus according to claim 12 characterized by the fact that said pressure gauge is connected to a serial circuit of a direct current power source and a receiver in a two-line transfer system via a connection cable.
